(19) United States
(12) Patent Application Publication
(10) Pub. No.: US 2025/0217634 A1
(43) Pub. Date: Jul. 3, 2025

(54) LIKELIHOOD-BASED DYNAMIC GRAPH PREDICTION

(71) Applicant: Microsoft Technology Licensing, LLC, Redmond, WA (US)

(72) Inventor: James William BONO, San Francisco, CA (US)

(21) Appl. No.: 18/399,161

(22) Filed: Dec. 28, 2023

(51) Int. Cl. G06N 3/0499; G06N 3/08

(52) U.S. Cl. CPC G06N 3/0499; G06N 3/08

(57) ABSTRACT

Dynamic graph prediction can be achieved using a statistical model of graph dynamics that combines neural networks, including graph neural networks (GNNs), with maximum likelihood estimation. More specifically, in some embodiments, a GNN is used to compute graph embeddings representing an evolving graph at two different points in time, an additional neural network is used to create a forward image of the graph embedding associated with the first point in time, and a statistical distribution of the difference between the forward image and the graph embedding associated with the second point in time is evaluated. The GNN, additional neural network, and statistical distribution collectively constitute the statistical model, which can be trained on training data comprising pairs of graphs from one or more time series of evolving graphs. Such a statistical model may be employed, for example, to predict graph changes in a cybersecurity incident graph.

### BACKGROUND

A common task in cybersecurity is the prediction how a graph will change over time. The graph may, for example, represent a security incident, with nodes corresponding to network assets (e.g., machines, applications, users, etc.) or security alerts, and edges corresponding to relationships (e.g., network connections, common characteristics, etc.) between the assets or alerts. The evolution of such a graph over time can capture how a cyberattack unfolds, and predicting changes in the graph, accordingly, provides opportunities for thwarting the attack or at least mitigating the risk and limiting damage by taking appropriate actions, such as shutting down or isolating affected machines, revoking compromised user credentials, or backing up vital data, among others.

### BRIEF DESCRIPTION OF THE DRAWINGS

Described herein, with reference to the accompanying drawings, is a framework for graph prediction that combines graph neural networks (GNNs) with maximum likelihood estimation (MLE) to formulate a statistical model of graph dynamics.

FIG. 1 is a block diagram of an example computer network and associated cybersecurity system in which likelihood-based dynamic graph prediction in accordance with various embodiments may be implemented.

FIG. 2 is a schematic diagram illustrating the computation of graph embeddings for two graphs in a time series, in accordance with various embodiments.

FIG. 3 is a graph illustrating comparisons between likelihoods of different graphs using a multivariate normal distribution, in accordance with various embodiments.

FIG. 4 is a flowchart of an example method of training a statistical model of graph dynamics, in accordance with various embodiments.

FIG. 5 is a flowchart of an example method of using a statistical model of graph dynamics to assess relative probabilities of multiple candidate future graphs, in accordance with various embodiments.

FIG. 6 is a flowchart of an example method of applying a statistical model of graph dynamics to the predicting of graph changes in a cybersecurity incident, in accordance with one embodiment.

FIG. 7 is a block diagram of an example computing machine that may be configured to perform the computational methods described herein.

### DESCRIPTION

This disclosure provides systems and methods for creating a statistical model of graph dynamics, and subsequently leveraging the model to probabilistically predict, based on a snapshot of a given graph at one point in time, the evolved graph at a future point in time. A graph is defined as set of nodes, along with a set of edges connecting pairs of the nodes. Optionally, the nodes and/or the edges may have associated attributes, such as categorical attributes reflecting, e.g., classifications, or numerical attributes representing, e.g., weights. A dynamic graph is a graph that changes over time, e.g., via the addition or deletion of nodes and edges and/or changes to any node or edge attributes. The dynamic graph can be represented as a time series of graphs, e.g., a series of snapshots at even time intervals or at an ordered set of points in time at which the graph changes.

In various embodiments, graph prediction as described herein is applied, in the context of cybersecurity, to graphs representing computer networks, e.g., with nodes corresponding to machines and other network assets and edges encoding connections or associations between the network assets. However, as will be readily apparent to those of ordinary skill in the art, the described graph prediction framework is not limited to computer networks or cybersecurity applications, but is more generally applicable to any dynamic graph, regardless of what the nodes and edges represent. Graph prediction may, for instance, be used to generate recommendations for participants in social networks, detect fraud in webs of financial transactions, or simulate the physics of many-particle systems.

Graph prediction is a complex and challenging task for various reasons. Changes may simultaneously affect the nodes and edges as well as their attributes, and changes of the nodes, edges, and attributes may be correlated with each other as well as over time. At any given time, the possible future graphs are manifold and escape straightforward enumeration. Moreover, the set of future graphs itself changes over time. Existing link and/or edge prediction approaches do not capture the correlation among the various possible changes to the graph, and therefore do not report the relative likelihood of various possible sets of changes. The disclosed approach to graph prediction addresses these challenges, and captures the complexities of graph evolution, with a statistical model of graph dynamics that combines GNNs and MLE.

In the disclosed statistical model of graph dynamics, a GNN is used to map input representations of graphs onto respective graph embeddings. An additional, feedforward neural network (FNN), such as a multi-layer perceptron (MLP), can then operate on a graph embedding for a first point in time to predict a graph embedding for a subsequent second point in time; this predicted graph embedding is herein also referred to as a “forward image” of the graph embedding associated with the first point in time. A statistical distribution, such as, e.g., a multivariate normal distribution, is used to model the difference between the forward image and a graph embedding of a graph representation of the actual graph at the second point in time, reflecting the heuristic that graphs generally do not evolve deterministically, at least from the perspective of the scientist, but according to statistics allowing for multiple possible future graphs. The free parameters of the neural networks (e.g., GNN and FNN) and the statistical distribution may be determined by training the statistical model on pairs of graph representations each corresponding to two successive graphs in a time series representing an evolving graph, using maximum likelihood estimation; the likelihood function used in training represents the joint probability, given the statistical distribution, of the differences across the training data pairs between the forward image of the graph embedding of the first graph representation and the graph embedding of the second graph representation. In some embodiments, the parameters of the statistical distribution are fixed at the outset, allowing joint training of the neural networks by backpropagation of gradients of the likelihood function. In this framework, the statistical distribution is implicitly parameterized by the GNN and the FNN, thereby leveraging the properties of the learned statistical model (such as the relative probabilities of possible next graphs, and including the correlations among the various possible changes to the graphs) for analysis.

Beneficially, using the approach proposed herein allows capturing any arbitrary correlation structure between changes in various elements of the graph (e.g., nodes, edges, attributes), provides relative probabilities of any two future graphs, and leverages well-studied distributions as the object of predictive analysis.

Following this high-level overview, various example embodiments will now be described with reference to the accompanying drawings.

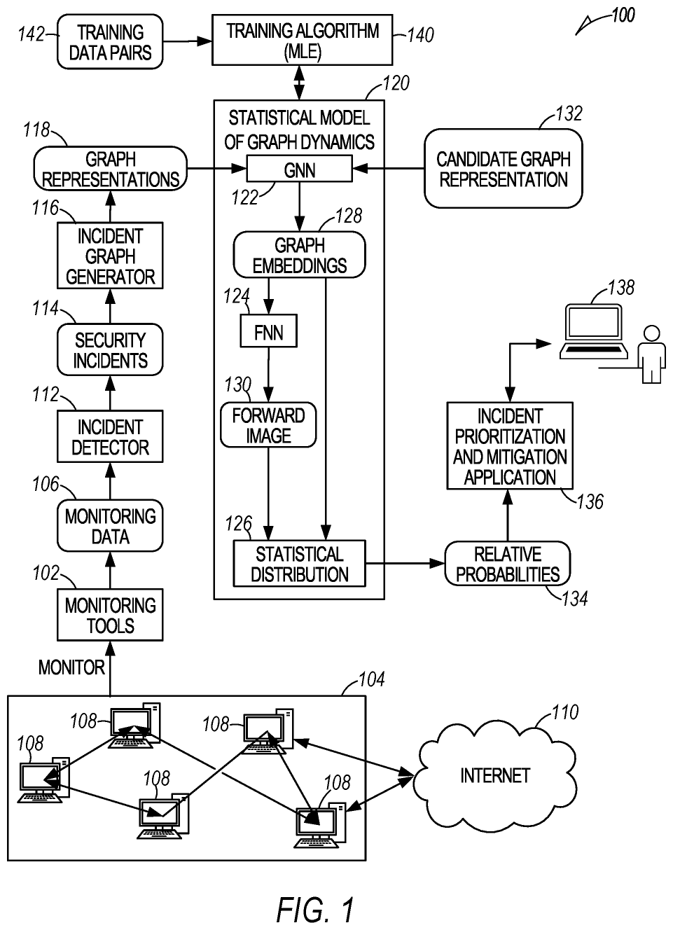

FIG. 1 is a block diagram of an example computer network and associated cybersecurity system, collectively system 100, in which likelihood-based dynamic graph prediction in accordance with various embodiments may be implemented. The system 100 includes one or more network security and/or other monitoring tools 102 that monitor the communications and activities within a computer network 104, and generate monitoring data 106. The monitoring data 106 may, in particular, include time-stamped records of security events, herein broadly understood to encompass any observed event within the network (e.g., network communications, machine accesses by users or other machines, program launches, etc.) that is deemed relevant to assessing network security; security events include, for example, the kinds of unusual or suspicious observed network events that trigger security alerts.

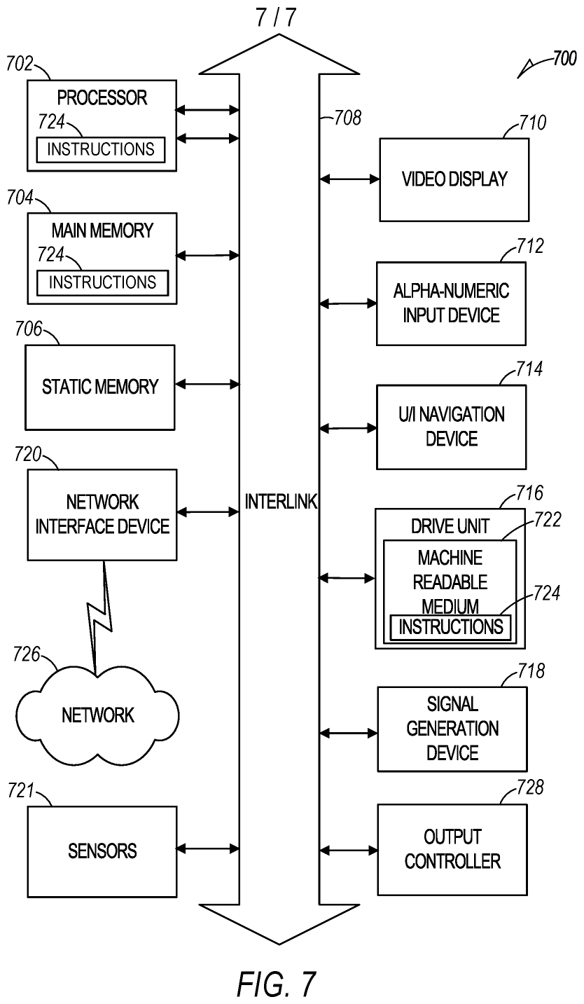

The computer network 104 includes multiple (e.g., often a large number of) computing machines 108, which can be accessed by users, store data, execute programs, and communicate with each other as well as with machines outside the organization via suitable wired or wireless network connections. In some embodiments, internal communications within the computer network 104 take place via a local area network (LAN) implemented, e.g., by Ethernet or Wi-Fi, or via a private wide area network (WAN) implemented, e.g., via optical fiber or circuit-switched telephone lines. External communications may be facilitated via the Internet 110. The computing machines 108 within the computer network 104 may include, e.g., servers, desktop or laptop computers, mobile devices (e.g., smartphones, tablets, personal digital assistants (PDAs)), Internet-of-things devices, etc. The computing devices 108 may each include one or more (e.g., general-purpose) processors and associated memory; an example computing machine is described in more detail below with reference to FIG. 7. The computing machines 108 and clusters thereof, files, databases, etc. stored on the machines 108; software executed on the machines; network interfaces and ports (e.g., as identified by IP addresses and port numbers); users; and other associated entities are herein all referred to as “assets” of the computer network 104.

To protect the computer network 104 from unauthorized access, data theft, malware attacks, or other cyberattacks, the network 104 is monitored, as noted above, by a number of monitoring tools 102, which may be implemented as software tools running on general-purpose computing hardware (e.g., any of the computing machines 108 within the computer network 104) and/or dedicated, special-purpose hardware security appliances. The monitoring tools 102 include, in particular, network security tools such as, for example and without limitation, firewalls that monitor and control network traffic, anti-malware software to prevent the installation of or remove computer viruses and the like, intrusion detection and prevention systems that scan network traffic to identify and block attacks, network anomaly detectors to spot malicious network behavior, authentication and authorization systems to identify users and implement access controls, application security tools to find and fix vulnerabilities in software applications, email security tools to detect and block email-born threats, data loss prevention software to detect and prevent data breaches, and/or endpoint protection systems to safeguard data and processes associated with the individual computing machines 108 serving as entry points into the computer network 104. In some embodiments, comprehensive protection is provided by multiple security tools bundled into an integrated security suite. Sometimes, multiple such integrated security suites from different vendors are even used in combination for complementary protection. Security solutions may employ “security information and events management (SIEM)” to collect, analyze, and report security-event records across the different security products (e.g., different security tools or integrated security suites), e.g., to provide security analysts with aggregate information in a console view or other unified format. Further, to meet the growing complexity and sophistication of cyberattacks, “extended detection and response (XDR)” may perform intelligent automated analysis and correlation of security-event records across security layers (e.g., email, endpoint, server, cloud, network) to discern cyberattacks even in situations where they would be difficult to detect with individual security tools or SIEM; one nonlimiting example of an XDR product is Microsoft 365 Defender.

The monitoring tools 102 generate a wealth of data that is processed and acted on by various processing components of the system 100, which, like the monitoring tools 102 themselves, may be implemented in software running on general-purpose computing hardware (e.g., any of the computing machines 108 within the computer network 104), optionally aided by hardware accelerators (e.g., graphic processing units (GPUs), field-programmable gate arrays (FPGA)s, or application-specific integrated circuit (ASICs)) configured for certain computationally expensive, but repetitive processing tasks.

As depicted, the processing components may include an incident detector 112, which groups security alerts and events into security incidents 114 each corresponding to a collection of events that appear to relate to the same cyberattack and should, accordingly, be considered together. For example, a malware attack may be carried out through a malicious email attachment sent to multiple users, and these emails, along with any user action to save or execute the attachment as well as any network activities that result from such execution may constitute a collection of individual security events that all belong to a single incident 114. As another example, a cyberattack generally proceeds through a sequence of stages in the “cyber kill chain” (including, e.g., reconnaissance, initial access or infiltration, lateral movement through the network, exfiltration, weaponization and exploitation, command and control, and/or data theft, data destruction, sabotage, or other harm), and the actions occurring along the kill chain may be aggregated into a single incident 114. Incident detection may be accomplished, for instance, by clustering security events and alerts, e.g., based on correlations and shared attributes. Aggregating security events into incidents 114 serves to cut down on the number of items to be reviewed by security analysists or processed by automated mitigation tools, and provides a more holistic view of the attack than individual alerts, and thus the potential ability to respond more comprehensively and appropriately.

The processing components may further include an incident graph generator 116 that operates on the monitoring data 106 associated with an incident 114, optionally in conjunction with data from other sources, to create a graph representation 118 of the incident. In some embodiments, creating the incident graph representation 118 involves, first, identifying all network assets implicated in the security incident 114, optionally adding network assets within an n-step neighborhood of the implicated assets, and determining attributes of the assets, such as asset types, data classification, known vulnerabilities, risk findings, posture, and associated security alerts. The security alerts may themselves have attributes, such as category, severity, associated IP address, threat actors, and/or tactics, techniques, and procedures (TTPs). The network assets may be viewed as the nodes of a graph, and may be represented by vectors encoding their attributes. The node vectors may be concatenations of vectors representing the individual attributes, such as one-hot encodings of categorical attributes, or vector-embeddings of textual attributes created by a large language model (LLM) or other text-embedding model. Connections and associations between the assets may be represented as edges between the nodes. For example, a network connection between two machines may be represented as an edge between the nodes representing the machines in the graph; a user accessing a machine may be represented as an edge between two nodes representing the user and the machine, respectively; storage of a file on a machine may be represented by two nodes representing the file and the machine, respectively; and so on. Associations between nodes may also be established based on shared or similar attributes. For instance, two machines or programs may be connected with each other based on a shared group of users or implication in the same security alert, to provide just a couple of examples. The edges of the graph may be represented by an adjacency matrix, which may be non-binary in cases where the edges are weighted. Optionally, the edges may have attributes, which may be encoded in associated edge vectors, for example. Based on the representations of the nodes and edges, such as based on the node vectors in conjunction with the adjacency matrix, a vector representation of the graph as a whole may be computed to serve as the graph representation 118. Suitable algorithms for creating such whole-graph representations or embeddings include GraphSAGE, among many techniques known to those of ordinary skill in the art. Such whole-graph embedding techniques may be inductive (as opposed to transductive), and as such would be learned on graphs in training data and thereafter applied to new graphs.

To facilitate graph prediction in accordance herewith, the processing components further include a statistical model of graph dynamics 120, which includes a GNN 122, an MLP or other FNN 124, and a statistical distribution 126. The GNN 122 creates, from the initial graph representations 118 generated by the incident graph generator 116, graph embeddings 128. The FNN 124 generates, as needed, forward images 130 of the graph embeddings 128 (which themselves are graph embeddings). The statistical distribution 126 measures the probability of a difference between two graph embeddings, in accordance herewith generally the difference between a forward image of a first graph embedding associated with a first time and a second graph embedding associated with a second time. Note that the graph embeddings and forward image can all be represented as vectors that share a common size or dimensionality. The “vector difference” or simply “difference” between two such vectors, as herein understood, is the vector resulting from component-wise subtraction of one of the two vectors from the other. In various embodiments, the second graph embedding is computed from a candidate graph representation 132 provided to the statistical model 120 separately from the output of the incident graph generator 116. The output of the statistical model 120, which may include relative probabilities 134 computed for multiple candidate graph representations 132 compared against the forward image of the graph embedding of a current incident graph, may be provided to an incident prioritization and mitigation application 136. The term “relative probabilities” herein denotes a set of values computed for the multiple candidate graph representations that are proportional to the actual probabilities of the respective graphs they represent, such that the ratio of the computed values for any two of the candidate graph representations reflects the ratio of the actual probabilities of the respective graphs.

The incident prioritization and mitigation application 136 may provide the computed relative probabilities 134, that is, the probability of any of the candidate graphs relative to any other of the candidate graphs, along with information about the candidate graphs from which the candidate graph representations 132 were derived, to a security analysist 138 via a suitable user interface. The information about the candidate graphs may include assessments of the severity of possible future incidents represented by the candidate graphs. Alternatively, the information may include depictions of the candidate graphs, e.g., with identifiers of the nodes and/or information about attributes of the nodes and/or edges, from which the security analysist 138 may assess the severity of the possible future incidents. In many application contexts, the incident prioritization and mitigation application 136 provides information about multiple active security incidents, along with probabilistic predictions of their future evolution in terms of the relative probabilities of candidate graphs for each. Based on the relative probabilities 134 in conjunction with the assessed severities, the security analysist 138 can prioritize the security incidents, and take appropriate mitigating actions. In some embodiments, prioritization and/or the selection of mitigating actions are in whole or in part automated by the application 136. Mitigating actions may include, for example and without limitation: suspending network accounts, requiring that users reset their passwords or otherwise causing authentication credentials to be reset, isolating affected machines, performing scans for viruses and other malware, de-installing identified malware, removing persistence mechanisms (e.g., registry entries, scheduled tasks, etc.) associated with the attack, sending warnings (e.g., about phishing attacks or email attachments containing malware) to network users, backing up valuable information, restoring destroyed data from back-up copies, taking stock of exfiltrated data that might include customer information or trade secrets, fixing security bugs, increasing the level of network traffic monitoring, notifying authorities, etc. The implementation of some of these actions may be accomplished, e.g., using the security tools also employed as monitoring tools 102.

The system 100 may further include a component implementing a training algorithm 140 involving maximum likelihood estimation to train the statistical model 120 based on training data pairs 142. The training data pairs may include pairs of successive graph representations created from data collected within the system 100 about the computer network 104, but may also include graph representations from external sources. For example, the statistical model of graph dynamics 120 may be trained based on training data derived from cybersecurity data aggregated across multiple organizations. Once the model 120 has been trained, it may be deployed separately from the training algorithm; that is, the system 100 need not include the training algorithm and training data, but may simply implement an already trained model 120.

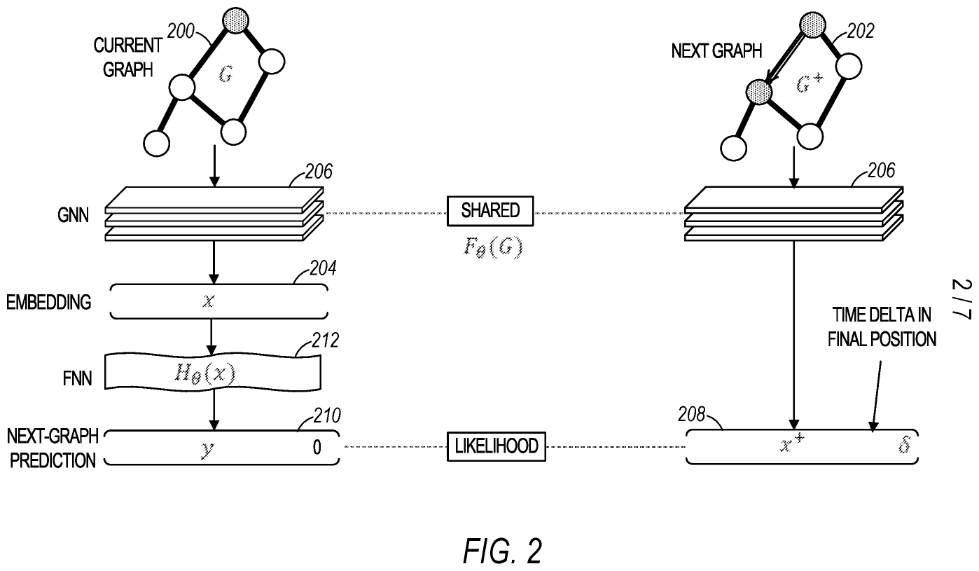

FIG. 2 is a schematic diagram illustrating the computation of graph embeddings for two graphs in a time series, in accordance with various embodiments, illustrating the operation of the statistical model of graph dynamics 120 in more detail. To formally describe the operation of the model, let Γ={(Gᵢ, Gᵢ, δᵢ)}ᵢ be a set of pairs of graph representations of a current graph 200 (Gᵢ) associated with a first time and a subsequent graph 202 (Gᵢ⁺) associated with a second time (herein also the “next graph”), with a time interval δᵢ between the first and second times. The graphs Gᵢ and Gᵢ⁺ may, for example, be successive graphs in a time series of graphs. More generally, Gᵢ and Gᵢ⁺ may be any two graphs in the time series separated by δᵢ. In the depicted example, the filled node(s) in the graphs represent assets that have been implicated in alerts belonging to the incident represented by the graph. As can be seen, the current graph 200 includes only one such node, but in the next graph 202, a second node has been affected by the attack.

Now, let xᵢ=F_{θ}(Gᵢ)∈ [symbol] ^{D} be a D-dimensional embedding 204 of the current graph 200 produced by a GNN 206 having parameters θ and generally including multiple (e.g., a few) layers, and let xᵢ⁺=F_{θ}(Gᵢ⁺)∈ [symbol] ^{D} be a D-dimensional embedding of the next graph 202 produced by the same GNN 206. Next, let yᵢ=H_{ϕ}(xᵢ)∈ [symbol] ^{D} be the forward image of the current graph 200 in the embedding space that results from application of a dimension-preserving FNN 212 (e.g., a dimension-preserving MLP) with parameters ϕ applied to the current-graph embedding 204. The initial embedding of the next graph, xᵢ⁺, may be augmented by an additional element storing the time interval δᵢ, resulting in a (D+1)-dimensional augmented embedding 208, [symbol] , and the initial forward image of the current graph, yᵢ, may be augmented by an additional element equal to zero to produce an augmented forward image 210, \tilde{y}, that is likewise (D+1)-dimensional.

Then, an embedding difference vector zᵢ= [symbol] −\tilde{y}_{ι} may be computed as the vector difference (that is, the component-wise difference) between the augmented next graph embedding 208 and the augmented forward image 210 of the current graph embedding 204. Alternatively, in embodiments that omit the augmentation, the embedding difference vector an embedding difference vector zᵢ=xᵢ⁺−yᵢ may be computed as the vector difference between the (initial) next graph embedding and the (initial) forward image of the current graph embedding 204.

The statistical model can be formulated based on the set of embedding difference vectors {zᵢ}ᵢ derived from the data, Γ, in terms of the following likelihood function:

$$ℒ ( Γ ; θ , ϕ , λ ) = {\prod }_{i} P ( {z}_{j} ; λ ) ,$$

which provides the joint probability of the vector differences zᵢ of the training data pairs (Gᵢ, Gᵢ⁺) given the statistical distribution P (zᵢ; λ), computed as the product of the likelihoods (probabilities) of the individual vector differences zᵢ. Herein, λ represents the parameters of the statistical distribution P(zᵢ; λ). For example, if P is a multivariate normal distribution (that is, an N-dimensional Gaussian distribution, where N is the dimensionality of the embedding difference vector zᵢ), then λ=(μ, Σ) includes the mean vector μ and covariance matrix Σ. Other possible choices for P are multivariate exponential, beta, logistic, gamma, or other continuous statistical distributions. The choice of distribution is generally a matter of predictive performance, not unlike a hyperparameter of the framework determined through cross validation. In general, the parameters Δ of the statistical distribution can be determined along with the parameters (θ, ϕ) of the neural networks as part of training the statistical model on the training data. However, to simplify the formulation and parameter estimation, the parameters Δ are fixed in some embodiments. For example, the statistical distribution P may be taken to be a standard normal distribution with mean zero and the covariance matrix being the identity matrix. Intuitively, this choice pushes all of the work of fitting the data into the GNN 206 and FNN 212, F_{θ} and H_{ϕ}. Beneficially, this choice enables training the model entirely through backpropagation of the gradients of the likelihood function £(Γ; θ, ϕ) (or log-likelihood function).

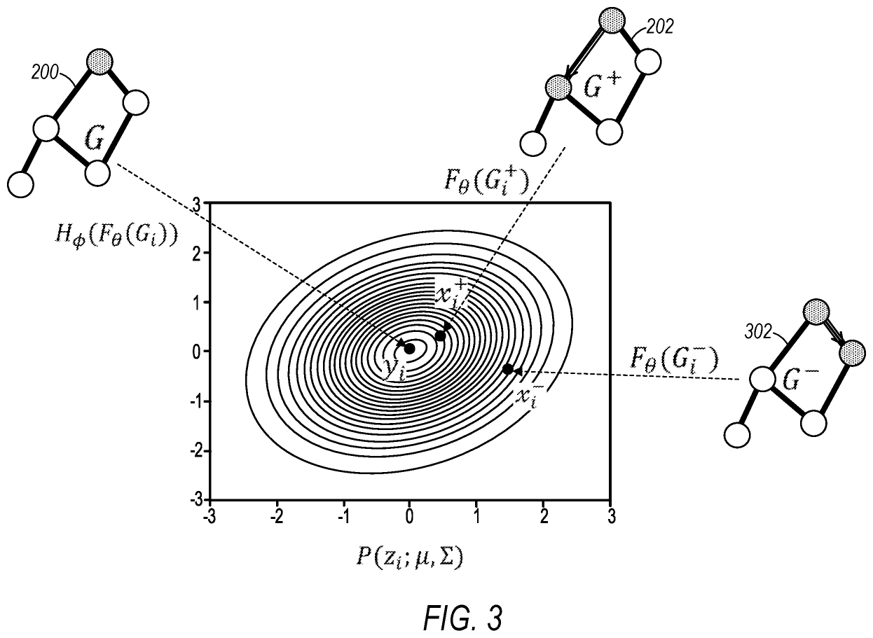

FIG. 3 is a graph illustrating comparisons between likelihoods of different graphs using a multivariate normal distribution, in accordance with various embodiments. Here, Gᵢ⁻ is an example of an alternative graph 302 that was not the actual next graph Gᵢ⁺. The distribution is a multivariate standard normal distribution with λ=(μ, Σ). The probability of Gᵢ⁺ relative to Gᵢ⁻ (in other words, the “relative probability” between Gᵢ⁺ and Gᵢ⁻) is simply the ratio of the height of P(zᵢ; λ) to the height of P(zᵢ⁻; λ). To make predictions about the next graph given a current graph, one only needs a (domain-specific) method to sample candidate next graphs and compare their likelihoods (e.g., compute their pairwise relative probabilities) using P.

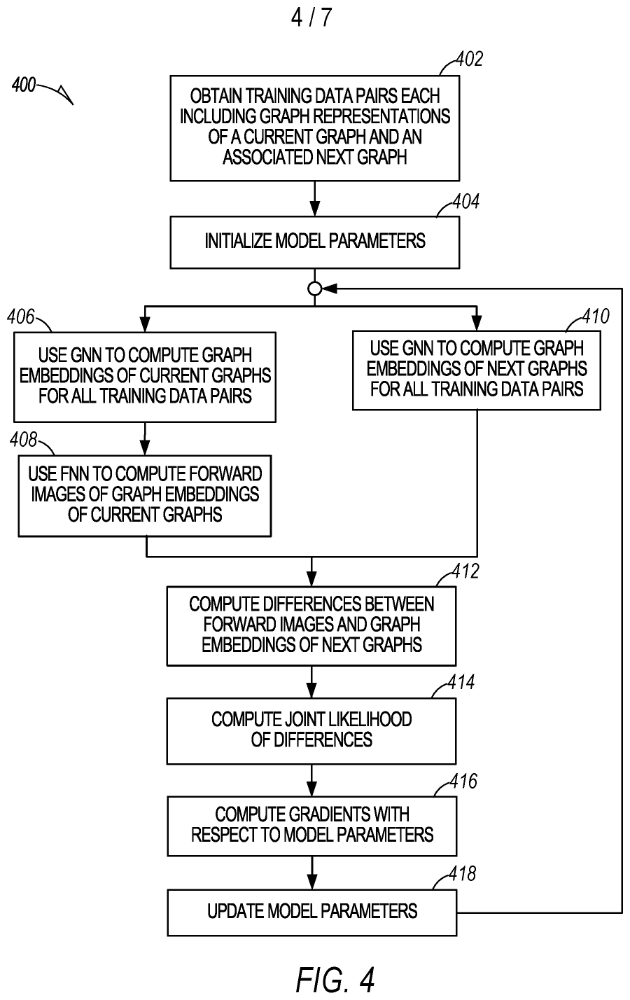

FIG. 4 is a flowchart of an example method 400 of training a statistical model of graph dynamics (as illustrated in FIGS. 2 and 3), in accordance with various embodiments. It is assumed, in this example, that the parameters of the statistical distribution P are fixed. The method 400 involves obtaining training data pairs each including first and second graph representations of a time series of graph representations of a dynamically evolving graph, representing a graph at a first time (the current graph) and a graph at a later second time (the next graph), respectively (402). The training data pairs may all be derived from a single time series representing a single dynamically evolving graph, where the current graphs of different training data pairs correspond to different points in time. Alternatively, the training data may be derived from pairs of graphs of multiple different time series representing different dynamically evolving graphs.

The training involves, following initialization of the model parameters (that is, the parameters or “weights” of the neural networks of the model) (404), iteratively updating the model parameters to maximize the joint probability of differences computed for the training data pairs between a forward image of a first graph embedding computed from the first graph representation and a second graph embedding computed from the second graph representation. In more detail, in each iteration, graph embeddings of the current graphs of the training data pairs are computed from the respective first graph representations using the GNN (406), and those embeddings are forward-imaged with the dimension-preserving FNN (408). Further, graph embeddings of the next graphs of all training data pairs are computed from the respective second graph representations using the GNN (410). The initially computed forward images of the graph embedding of the current graphs and the initially computed graph embeddings of the next graphs may be augmented with zero and the time difference between the current and next graphs, respectively, as explained with reference to FIG. 2.

Next, the differences between the forward images of the graph embeddings for the current graphs and graph embeddings for the respective next graphs are computed (412), and their joint probability (that is, the product of their probabilities) is computed using the statistical distribution (414); this joint probability constitutes the value of the likelihood function for the current set of model parameters. Gradients of the likelihood function with respect to the model parameters are then computed (416) and used to update the model parameters (418) by backpropagation to increase the likelihood function. The iterative process continues until the likelihood function is maximized to a specified degree.

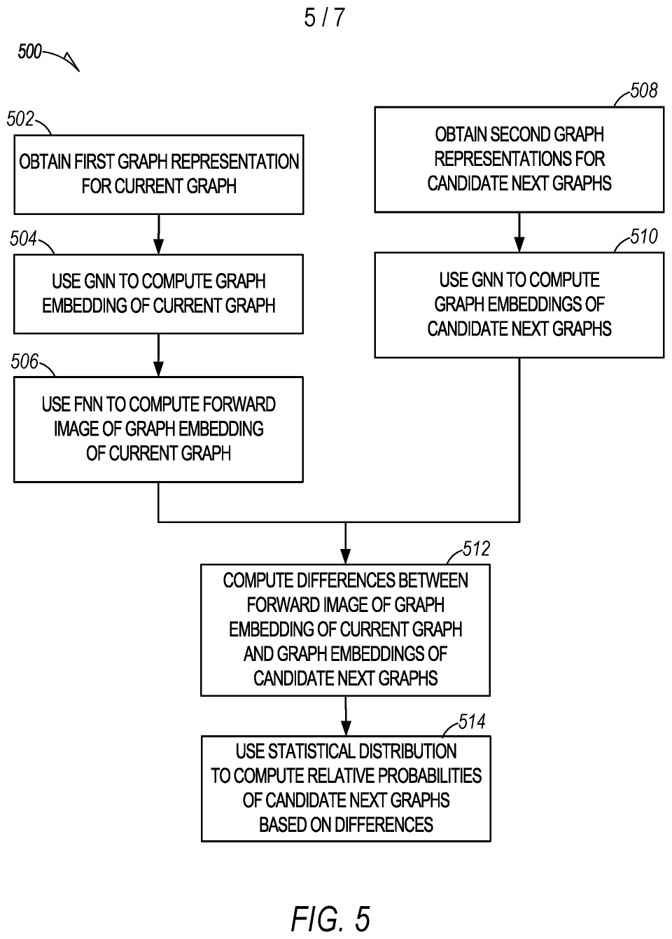

FIG. 5 is a flowchart of an example method 500 of using a statistical model of graph dynamics to assess relative probabilities of multiple candidate future graphs, in accordance with various embodiments. The method 500 involves obtaining a first graph representation corresponding to an observed dynamically evolving graph at a first time (the current graph) (502), using the trained GNN to compute a graph embedding of the current graph (504), and using the FNN to forward-image the graph embedding (506).

To predict the evolution of the graph, the method 500 further involves obtaining a plurality of candidate second graph representations corresponding to the dynamically evolving graph at a later second time (508); in other words, the candidate second graph representations reflect possible future graphs. The future, or next, graphs can be obtained by different methods. In one embodiment, the current graph is randomly varied to create the candidate next graphs. Such random variation can be achieved by randomly selecting one or more edges for deletion, randomly selecting one or more pairs of previously unconnected nodes for connection by a new edge, randomly selecting one or more nodes for deletion (along with their associated edges), adding one or more new nodes and randomly connecting them to each other or to previously existing nodes, randomly varying attributes associated with randomly selected nodes or edges, or any combination of the foregoing. In another embodiment, the next graphs are selected from a set of graphs by random or weighted sampling (e.g., sampling in accordance with a uniform or non-uniform distribution). The set of graphs and/or the distribution used to sample them may be derived from historical graph evolution data. For example, based on historical data, the simple probabilities of an incident evolving from one type of asset to another type or from one alert type to another type may be estimated, and then the next asset or alert type may be selected from the graph according to those probabilities. In whatever way the candidate next graphs are obtained, they can be converted into graph representations in the same manner as the current graph. Next, the GNN is used to compute graph embeddings of the candidate graph representations (510), and vector differences between the (e.g., augmented) forward image of the graph embedding of the current graph and the (e.g., augmented) graph embeddings of the candidate next graphs are calculated (512). Finally, those differences are fed into the statistical model to compute relative probabilities of the candidate next graphs (514).

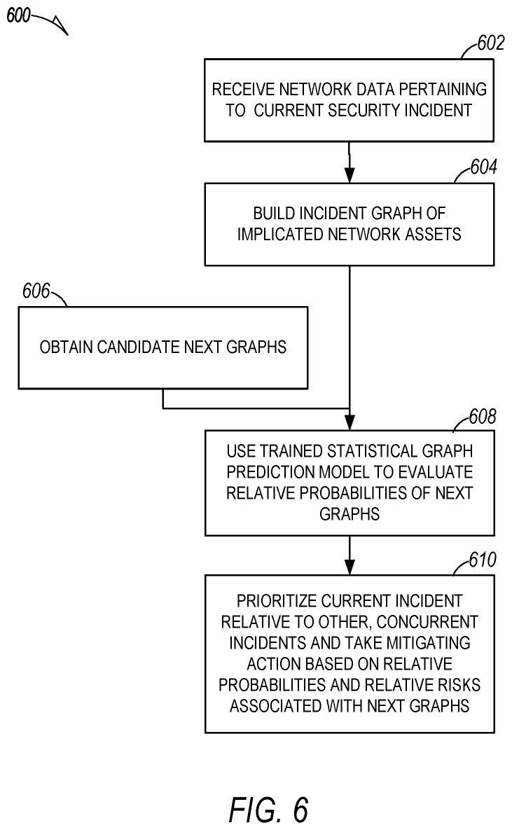

FIG. 6 is a flowchart of an example method 600 of applying a statistical model of graph dynamics to the prediction of graph changes in a cybersecurity incident, in accordance with one embodiment. The method 600 can be implemented, e.g., using the system 100 of FIG. 1. The method 600 starts with receiving data pertaining to a current security incident (602), and creating an incident graph from the data (602). The nodes in the incident graph include network assets implicated in the security incident, optionally augmented by additional network assets in their neighborhood. Further, the method 600 involves obtaining two or more candidate next graphs (606), e.g., in a manner as described in conjunction with FIG. 5. Then, using a suitable trained statistical model of graph dynamics, e.g., created based on training data pertaining to evolving incident graphs of many historical security incidents, the relative probabilities of pairs of the candidate next graphs are evaluated in terms of ratios of probabilities, pursuant to the statistical distribution, of the differences of their respective graph embeddings from a forward image of a graph embedding of the current graph. The current incident can then be prioritized relative to other, concurrent incidents, and appropriate mitigating actions can be implemented, based on the relative probabilities of the candidate next graphs in conjunction with the relative risks they pose (610). For example, candidate next graphs with relatively low probability or low associated security risks may be disregarded, and mitigating action may be selected based on the most probable next graphs, prioritizing the most severe threats among the most probable next graphs of multiple current incident graphs. In some embodiments, the selected next graph(s) implicitly predict the attacker's next steps in an ongoing attack, enabling better targeted mitigating actions. For example, if a particular user is likely to be attacked next, then the security analyst may decide to quarantine that user. Moreover, beyond responding to individual security incidents and attacks, the probabilistic graph prediction can be used to generate larger attack scenarios and develop and implement effective defense strategies based thereon. Graph prediction can also be applied retroactively to security incident graphs in forensic studies to help tracking and understanding possible breaches and impacts. For example, a likely outcome that was not realized may alert an analyst to the possibility that a critical asses was at high risk, thereby motivating posture improvements to that asset and surrounding assets.

FIG. 7 is a block diagram of an example computing machine that may be configured to perform the computational methods described herein. In alternative embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environment. The machine 700 may be a personal computer (PC), a tablet PC, a set-top box (STB), a personal digital assistant (PDA), a mobile telephone, a smartphone, a web appliance, a network router, switch or bridge, a server computer, a database, conference room equipment, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations. In various embodiments, machine(s) 700 may implement the computing system 100 of FIG. 1, and may perform one or more of the processes described above with respect to FIGS. 2-6.

Machine (e.g., computer system) 700 may include a hardware processor 702 (e.g., a central processing unit (CPU), a graphics processing unit (GPU), a hardware processor core, or any combination thereof), a main memory 704 and a static memory 706, some or all of which may communicate with each other via an interlink (e.g., bus) 708. The machine 700 may further include a display unit 710, an alphanumeric input device 712 (e.g., a keyboard), and a user interface (UI) navigation device 714 (e.g., a mouse). In an example, the display unit 710, input device 712 and UI navigation device 714 may be a touch screen display. The machine 700 may additionally include a storage device (e.g., drive unit) 716, a signal generation device 718 (e.g., a speaker), a network interface device 720, and one or more sensors 721, such as a global positioning system (GPS) sensor, compass, accelerometer, or other sensor. The machine 700 may include an output controller 728, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 716 may include a machine-readable medium 722 on which are stored one or more sets of data structures or instructions 724 (e.g., software) embodying or utilized by any one or more of the techniques or functions described herein. The instructions 724 may also reside, completely or at least partially, within the main memory 704, within static memory 706, or within the hardware processor 702 during execution thereof by the machine 700. In an example, one or any combination of the hardware processor 702, the main memory 704, the static memory 706, or the storage device 716 may constitute machine-readable media.

While the machine-readable medium 722 is illustrated as a single medium, the term “machine-readable medium” may include a single medium or multiple media (e.g., a centralized or distributed database, and/or associated caches and servers) configured to store the one or more instructions 724.

The term “machine-readable medium” may include any medium that is capable of storing, encoding, or carrying instructions for execution by the machine 700 and that cause the machine 700 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine-readable media may include non-transitory machine readable media. In some examples, machine-readable media may include machine-readable media that are not a transitory propagating signal.

The instructions 724 may further be transmitted or received over a communications network 726 using a transmission medium via the network interface device 720. The machine 700 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 720 may include one or more physical jacks (e.g., Ethernet, coaxial, or phone jacks) or one or more antennas to connect to the communications network 726. In an example, the network interface device 720 may include a plurality of antennas to wirelessly communicate using at least one of single-input multiple-output (SIMO), multiple-input multiple-output (MIMO), or multiple-input single-output (MISO) techniques. In some examples, the network interface device 720 may wirelessly communicate using Multiple User MIMO techniques.

Examples, as described herein, may include, or may operate on, logic or a number of components, modules, or mechanisms (all referred to hereinafter as “modules”). Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The following numbered examples are illustrative embodiments:

Example 1 is a method that includes: obtaining training data pairs of a first graph representation and a second graph representation of a time series of graph representations of a dynamically evolving graph, the second graph representation following the first graph representation in the time series; and creating a statistical model for dynamic graph prediction by jointly training a graph neural network (GNN) and a feedforward neural network (FNN) to maximize, based on a statistical distribution, a joint probability of vector differences, aggregated over the training data pairs, between a first vector comprising a forward image of a first graph embedding determined from the first graph representation and a second vector comprising a second graph embedding determined from the second graph representation of the respective training data pair, wherein the GNN is used to determine the first and second graph embeddings for the training data pairs, and the FNN is used to determine the forward images of the first graph embeddings.

Example 2 is the method of example 1, wherein the first vector further includes a vector element equal to zero and the second vector further includes a corresponding vector element equal to a time difference between the first and second graph representations.

Example 3 is the method of example 1 or example 2, wherein the statistical distribution is or includes a multivariate normal distribution.

Example 4 is the method of example 3, wherein the multivariate normal distribution is a standard normal distribution.

Example 5 is the method of any of examples 1-4, wherein parameters of the statistical distribution are fixed and the GNN and FNN are trained by backpropagation of gradients.

Example 6 is the method of any of examples 1-5, wherein the training data pairs include a first training data pair including first and second graph representations of a first time series of a first dynamically evolving graph and a second training data pair comprising first and second graph representations of a second time series of a second dynamically evolving graph that is different from the first dynamically evolving graph.

Example 7 is the method of any of examples 1-6, wherein the training data pairs comprise multiple pairs of first and second graph representations associated with a same time series of graph representations of a same dynamically evolving graph, different ones of the pairs being associated with different respective times within the same time series.

Example 8 is the method of any of examples 1-7, wherein the training data pairs include or consist of graph representations of at least one dynamically evolving graph representing a computer network, with nodes of the graph representing assets of the computer network and edges of the graph representing connections and associations between the assets.

Example 9 is the method of any of examples 1-8, further including, following creation of the statistical model for dynamic graph prediction: receiving an observed first graph representation of an observed dynamically evolving graph at a first time; receiving candidate second graph representations for the observed dynamically evolving graph at a second time; determining, with the trained GNN, an observed first graph embedding from the observed first graph representation and candidate second graph embeddings from the candidate second graph representations; determining, with the trained FNN, a forward image of the observed first graph embedding; determining, with the statistical distribution, relative probabilities of the candidate second graph representations based on vector differences between a first vector and respective second vectors, the first vectors including the forward image of the observed first graph embedding and the second vectors including the candidate second graph embeddings.

Example 10 is the method of example 9, further including selecting, among the candidate second graph representations, a most probable second graph representation based at least in part on the relative probabilities.

Example 11 is the method of example 10, wherein the observed dynamically evolving graph represents a security incident in a computer network, with nodes of the graph representing assets of the computer network and edges of the graph representing connections and associations between the assets derived at least in part from security alerts involved in the security incident. The method further includes selecting, based on the relative probabilities and on security risks associated with the candidate second graph representations, one of the second graph representations for mitigating action.

Example 12 is the method of example 11, wherein the mitigating action includes at least one of: suspending network accounts, sending warnings to network users, causing authentication credentials to be reset, isolating affected machines, preforming scans for malware, de-installing malware, removing a persistence mechanism associated with the security incident, backing up data, restoring destroyed data from back-up copies, identifying exfiltrated data, fixing security bugs, increasing a level of network traffic monitoring, and notifying authorities.

Example 13 is a system that includes one or more computer processors and one or more machine-readable media storing processor-readable instructions which, when executed by the one or more computer processors, cause the one or more computer processors to perform operations to implement the method of any of examples 1-12.

Example 14 is one or more machine-readable media that store processor-readable instructions which, when executed by one or more computer processors, cause the one or more computer processors to perform operations to implement the method of any of examples 1-12.

Example 15 is a method that includes: obtaining a first graph representation of a dynamically evolving graph at a first time; obtaining candidate second graph representations for the dynamically evolving graph at a second time; determining, with a graph neural network (GNN) of a statistical model for graph prediction, a first graph embedding of the first graph representation and second graph embeddings of the candidate second graph representations; determining, with a feedforward neural network (FNN) of the statistical model for graph prediction, a forward image of the first graph embedding; determining vector differences between a first vector comprising the forward image of the first graph embedding and second vectors comprising the second graph embeddings; and determining, with a statistical distribution of the statistical model, relative probabilities of the candidate second graph representations based on the vector differences.

Example 16 is the method of example 15, wherein the statistical model has been trained by maximum likelihood estimation on training data pairs of graph representations of a dynamically evolving graph at two respective times.

Example 17 is the method of example 16, wherein the maximum likelihood estimation includes jointly training the GNN and FNN to maximize, based on the statistical distribution, a joint probability of vector differences, aggregated over the training data pairs, between a vector comprising a forward image of a graph embedding of a first graph representation of the respective training data pair and a vector comprising a graph embedding of a second graph representation of the respective training data pair.

Example 18 is the method of any of examples 15-17, wherein the statistical distribution comprises a multivariate normal distribution.

Example 19 is the method of example 18, wherein the multivariate normal distribution is a standard normal distribution.

Example 20 is the method of any of examples 15-19, wherein nodes of the dynamically evolving graph represent assets of a computer network, and edges of the dynamically evolving graph represent connections and associations between the assets.

Example 21 is the method of example 20, wherein obtaining the graph representation includes: receiving security data associated with a security incident in the computer network associated with the first time, the data comprising security alerts involved in the security incident; constructing a graph dataset based on the data; and generating the first graph representation based on the graph dataset.

Example 22 is the method of example 21, further including selecting, based on the relative probabilities and on security risks associated with the candidate second graph representations, one of the second graph representations for mitigating action.

Example 23 is the method of example 22, wherein the mitigating action comprises at least one of: suspending network accounts, sending warnings to network users, causing authentication credentials to be reset, isolating affected machines, preforming scans for malware, de-installing malware, removing a persistence mechanism associated with the security incident, backing up data, restoring destroyed data from back-up copies, identifying exfiltrated data, fixing security bugs, increasing a level of network traffic monitoring, and notifying authorities.

Example 24 is the method of any of examples 21-23, further including monitoring the computer network to receive the security data.

Example 25 is the method of any of examples 15-24, wherein obtaining the plurality of candidate second graph representations includes: creating random variations of the dynamically evolving graph at the first time, the random variations comprising at least one of: addition or deletion of a node, addition or deletion of an edge, or modification of an attribute of a node or edge; and generating the candidate second graph representations from the random variations.

Example 26 is the method of any of examples 15-24, wherein obtaining the candidate second graph representations includes: sampling graphs from a set of graphs according to a distribution over the set derived from historical graph evolution data; and generating the candidate second graph representations from the sampled graphs.

Example 27 is a system that includes one or more computer processors and one or more machine-readable media storing processor-readable instructions which, when executed by the one or more computer processors, cause the one or more computer processors to perform operations to implement the method of any of examples 15-26.

Example 28 is one or more machine-readable media that store processor-readable instructions which, when executed by one or more computer processors, cause the one or more computer processors to perform operations to implement the method of any of examples 15-26.

Example 29 is a system comprising: one or more computer processors; and one or more machine-readable media storing processor-readable instructions which, when executed by the one or more computer processors, cause the one or more computer processors to perform operations comprising: obtaining training data pairs comprising a first graph representation and a second graph representation of a time series of graph representations of a dynamically evolving graph, the second graph representation following the first graph representation in the time series; creating a statistical model for dynamic graph prediction by jointly training, by backpropagation of gradients, a graph neural network (GNN) and a multi-layer perceptron (FNN) to maximize, based on a statistical distribution, a joint probability of vector differences, aggregated over the training data pairs, between a first vector comprising a forward image of a first graph embedding determined from the first graph representation and a second vector comprising a second graph embedding determined from the second graph representation of the respective training data pair, wherein the GNN is used to determine the first and second graph embeddings for the training data pairs and the FNN is used to determine the forward images of the first graph embeddings; and using the statistical model for dynamic graph representation to determine, for an observed graph representation of an observed dynamically evolving graph at a first observation time, relative probabilities of candidate graph representations for the observed dynamically evolving graph at a second observation time.

Example 30 is the system of example 29, wherein using the statistical model to determine the relative probabilities of the candidate graph representations comprises: determining, with the GNN, an observed graph embedding from the observed graph representation and candidate graph embeddings from the candidate graph representations; determining, with the FNN, a forward image of the observed graph embedding; determining vector differences between a vector comprising the forward image of the observed graph embedding and vectors comprising the candidate graph embeddings; and determining the relative probabilities of the candidate graph representations with the statistical distribution based on the vector differences.

Example 31 is the system of example 29 or example 30, wherein the statistical distribution includes a multivariate normal distribution.

Example 32 is the system of any of examples 29-31, wherein nodes of the observed dynamically evolving graph represent assets of a computer network, and wherein edges of the observed dynamically evolving graph represent connections and associations between the assets.

Example 33 is the system of example 32, wherein the operations further comprise: receiving security data associated with a security incident in the computer network, the data comprising security alerts involved in the security incident; constructing a graph dataset based on the data; and generating the observed graph representation based on the graph dataset.

Example 34 is the system of examples 32 or example 33, wherein the operations further include selecting, based on the relative probabilities and on security risks associated with the candidate graph representations, one of the candidate graph representations for mitigating action.

Example 35 is the system of example 34, wherein the mitigating action includes at least one of: suspending network accounts, sending warnings to network users, causing authentication credentials to be reset, isolating affected machines, preforming scans for malware, de-installing malware, removing a persistence mechanism associated with the security incident, backing up data, restoring destroyed data from back-up copies, identifying exfiltrated data, fixing security bugs, increasing a level of network traffic monitoring, and notifying authorities.

Although embodiments have been described with reference to specific example embodiments, it will be evident that various modifications and changes may be made to these embodiments without departing from the broader scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This description, therefore, is not to be taken in a limiting sense, and the scope of various embodiments is defined only by the appended claims, along with the full range of equivalents to which such claims are entitled.

What is claimed is:

1. A method comprising:
obtaining a first graph representation of a dynamically evolving graph at a first time;
obtaining candidate second graph representations for the dynamically evolving graph at a second time;
determining, with a graph neural network (GNN) of a statistical model for graph prediction, a first graph embedding of the first graph representation and second graph embeddings of the candidate second graph representations;
determining, with a feedforward neural network (FNN) of the statistical model for graph prediction, a forward image of the first graph embedding;
determining vector differences between a first vector comprising the forward image of the first graph embedding and second vectors comprising the second graph embeddings; and
determining, with a statistical distribution of the statistical model, relative probabilities of the candidate second graph representations based on the vector differences.

2. The method of claim 1, wherein the statistical model has been trained by maximum likelihood estimation on training data pairs of graph representations of a dynamically evolving graph at two respective times.

3. The method of claim 2, wherein the maximum likelihood estimation comprises jointly training the GNN and FNN to maximize, based on the statistical distribution, a joint probability of vector differences, aggregated over the training data pairs, between a vector comprising a forward image of a graph embedding of a first graph representation of the respective training data pair and a vector comprising a graph embedding of a second graph representation of the respective training data pair.

4. The method of claim 1, wherein the statistical distribution comprises a multivariate normal distribution.

5. The method of claim 4, wherein the multivariate normal distribution is a standard normal distribution.

6. The method of claim 1, wherein nodes of the dynamically evolving graph represent assets of a computer network, and wherein edges of the dynamically evolving graph represent connections and associations between the assets.

7. The method of claim 6, wherein obtaining the graph representation comprises:
receiving security data associated with a security incident in the computer network associated with the first time, the data comprising security alerts involved in the security incident;
constructing a graph dataset based on the data; and
generating the first graph representation based on the graph dataset.

8. The method of claim 7, further comprising:
selecting, based on the relative probabilities and on security risks associated with the candidate second graph representations, one of the second graph representations for mitigating action.

9. The method of claim 8, wherein the mitigating action comprises at least one of: suspending network accounts, sending warnings to network users, causing authentication credentials to be reset, isolating affected machines, preforming scans for malware, de-installing malware, removing a persistence mechanism associated with the security incident, backing up data, restoring destroyed data from back-up copies, identifying exfiltrated data, fixing security bugs, increasing a level of network traffic monitoring, and notifying authorities.

10. The method of claim 7, further comprising:
monitoring the computer network to receive the security data.

11. The method of claim 1, wherein obtaining the plurality of candidate second graph representations comprises:
creating random variations of the dynamically evolving graph at the first time, the random variations comprising at least one of: addition or deletion of a node, addition or deletion of an edge, or modification of an attribute of a node or edge; and
generating the candidate second graph representations from the random variations.

12. The method of claim 1, wherein obtaining the candidate second graph representations comprises:
sampling graphs from a set of graphs according to a distribution over the set derived from historical graph evolution data; and
generating the candidate second graph representations from the sampled graphs.

13. A system comprising:
one or more computer processors; and
one or more machine-readable media storing processor-readable instructions which, when executed by the one or more computer processors, cause the one or more computer processors to perform operations comprising:
obtaining training data pairs comprising a first graph representation and a second graph representation of a time series of graph representations of a dynamically evolving graph, the second graph representation following the first graph representation in the time series;
creating a statistical model for dynamic graph prediction by jointly training, by backpropagation of gradients, a graph neural network (GNN) and a multi-layer perceptron (FNN) to maximize, based on a statistical distribution, a joint probability of vector differences, aggregated over the training data pairs, between a first vector comprising a forward image of a first graph embedding determined from the first graph representation and a second vector comprising a second graph embedding determined from the second graph representation of the respective training data pair, wherein the GNN is used to determine the first and second graph embeddings for the training data pairs and the FNN is used to determine the forward images of the first graph embeddings; and
using the statistical model for dynamic graph representation to determine, for an observed graph representation of an observed dynamically evolving graph at a first observation time, relative probabilities of candidate graph representations for the observed dynamically evolving graph at a second observation time.

14. The system of claim 13, wherein using the statistical model to determine the relative probabilities of the candidate graph representations comprises:
determining, with the GNN, an observed graph embedding from the observed graph representation and candidate graph embeddings from the candidate graph representations;
determining, with the FNN, a forward image of the observed graph embedding;
determining vector differences between a vector comprising the forward image of the observed graph embedding and vectors comprising the candidate graph embeddings; and
determining the relative probabilities of the candidate graph representations with the statistical distribution based on the vector differences.

15. The system of claim 13, wherein the statistical distribution comprises a multivariate normal distribution.

16. The system of claim 13, wherein nodes of the observed dynamically evolving graph represent assets of a computer network, and wherein edges of the observed dynamically evolving graph represent connections and associations between the assets.

17. The system of claim 16, wherein the operations further comprise:
receiving security data associated with a security incident in the computer network, the data comprising security alerts involved in the security incident;
constructing a graph dataset based on the data; and
generating the observed graph representation based on the graph dataset.

18. The system of claim 16, wherein the operations further comprise:
selecting, based on the relative probabilities and on security risks associated with the candidate graph representations, one of the candidate graph representations for mitigating action.

19. The system of claim 18, wherein the mitigating action comprises at least one of: suspending network accounts, sending warnings to network users, causing authentication credentials to be reset, isolating affected machines, preforming scans for malware, de-installing malware, removing a persistence mechanism associated with the security incident, backing up data, restoring destroyed data from back-up copies, identifying exfiltrated data, fixing security bugs, increasing a level of network traffic monitoring, and notifying authorities.

20. One or more machine-readable media storing processor-readable instructions which, when executed by one or more computer processors, cause the one or more computer processors to perform operations comprising:
obtaining a first graph representation of a dynamically evolving graph at a first time, the dynamically evolving graph representing a computer network, where nodes of the dynamically evolving graph represent assets of the computer network and edges of the dynamically evolving graph represent at least one of connections or associations between the assets;
obtaining candidate second graph representations for the dynamically evolving graph at a second time;
determining, with a graph neural network (GNN) of a statistical model for graph prediction, a first graph embedding of the first graph representation and second graph embeddings of the candidate second graph representations;
determining, with a feedforward neural network (FNN) of the statistical model for graph prediction, a forward image of the first graph embedding;
determining vector differences between a first vector comprising the forward image of the first graph embedding and second vectors comprising the second graph embeddings; and
determining, with a statistical distribution of the statistical model, relative probabilities of the candidate second graph representations based on the vector differences.
